(19) United States
(12) Patent Application Publication
(10) Pub. No.: US 2005/0145193 A1
(43) Pub. Date: Jul. 7, 2005

(54) Flavor enhanced rawhide pet chew

(76) Inventor: Robert J. Kirch, Parker, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/028,699

(22) Filed: Jan. 3, 2005

Related U.S. Application Data
(60) Provisional application No. 60/533,953, filed on Dec. 31, 2003.

(51) Int. Cl. A01K 29/00

(52) U.S. Cl. 119/710

(57) ABSTRACT

A flavored rawhide pet chew. The rawhide pet chew is formed by adding a flavor additive to at least a portion of a rawhide strip, then forming the strip into a chew. An unflavored portion of the formed strip typically covers the flavored portion of the rawhide strip.

### CROSS-REFERENCE TO RELATED APPLICATIONS

This application claims priority to U.S. provisional application Ser. No. 60/553,953, entitled “FLAVOR ENHANCED RAWHIDE PET CHEW” and filed on Dec. 31, 2003, which is incorporated in its entirety as if fully set forth herein. This application incorporates U.S. utility application Ser. No. 10/197,099 and entitled “RAWHIDE PET CHEW,” which is hereby incorporated by reference in its entirety as though fully set forth herein.

### BACKGROUND OF THE INVENTION

1. Field of the Invention

This invention relates to chew toys made for pets out of animal rawhide and their method of manufacture.

2. Description of the Related Art

Rawhide pet chews are staple products sold in the consumer pet product industry. Rawhide pet chews designed particularly for animals promote oral hygiene, provide a distraction, and reinforce the animal owner's relationship with the animal. The tough, dried rawhide of the pet chews cleans tartar and plaque off the animal's teeth when chewed. Additionally, the rawhide does not cause harm to the animal if ingested.

Unfortunately, not all animals are attracted to rawhide chews and, therefore, some pet owners cannot take advantage of this way to promote oral hygiene for their pets. In particular, some animals do not find the rawhide appetizing, primarily because of the lack of taste. In the typical manufacturing process of rawhide chews, the animal hides are stripped of any fat or sinew, then washed and whitened. This process inhibits spoilage and ensures a safe product for animals to ingest. However, this process also removes much of the fatty, oily taste of normal animal skin that is enticing to animals.

In order to overcome the problem of palatability of rawhide pet chews, manufacturers have attempted to add flavor to the rawhide. Methods for supplying flavor additives in the past have focused on marinating the hide in a liquid flavoring (typically prior to cutting the hide into specific shapes but after washing or otherwise treating the hide), and/or basting or spray coating the rawhide with a liquid flavoring. The liquid flavoring may include a gravy, marinade, or other flavor enhancement. Once coated with the liquid flavoring, the flavoring adheres to or forms a crust on the surface of the rawhide pet chew.

While such surface coatings are enticing to animals, they have several drawbacks. First, once an animal starts chewing on the pet chew, the animal's saliva reconstitutes the dried gravy coating. Many times these coatings contain brightly colored dyes as well. The wet, colored gravy coating often rubs off onto decorative surfaces on which the pet chew is laid, for example, carpeted floors and upholstered furniture, thereby soiling or staining the decorative surfaces. Such coatings may further stain the hair or fur around an animal's muzzle, discoloring the hair. This is especially noticeable in animals having light-colored fur. Additionally, once the coating is licked off by the animal, any future enticement to continue to chew the pet chew is gone and the pet chew may be ignored.

Accordingly, there is a need in the art for an improved rawhide pet chew.

### SUMMARY OF THE INVENTION

One embodiment of the present invention takes the form of a flavored rawhide pet chew. As used herein, “rawhide” generally refers to an untanned cow or other animal hide. The rawhide pet chew is formed by adding a flavor additive to at least a portion of a rawhide strip, then forming the strip. An unflavored portion of the formed strip typically covers the flavored portion of the rawhide strip. The chew may be a rolled stick or bone, a chip, or any other shape of rawhide chew product. The flavor additive may be applied as a dried powder, solid granules, liquid, or spray. The flavor additive may be applied to specific areas of the chew, such as the center of a rolled chew, or the knots at the end of a bone shaped chew. The flavor additive may also be added to a chew before or after the chew is processed by marinating or basting to provide additional incentive to the pet to chew the pet chew. Generally, when the flavor additive is added to a pet chew that is also basted or marinated, the flavor additive is added by a process separate from the marinating or basting.

### BRIEF DESCRIPTION OF THE DRAWINGS

FIG. 1A depicts a rawhide sheet having flavor additive added to a portion thereof.

FIG. 1B depicts a rawhide sheet having flavor additive added to a portion thereof.

FIG. 1C depicts a rawhide sheet having a liquid flavor additive added to a portion thereof.

FIG. 2 depicts a roll-shaped rawhide chew formed from the rawhide strip shown in FIG. 1A.

FIG. 3 depicts a bone-shaped rawhide chew having liquid flavor additive added thereto by means of a syringe.

### DETAILED DESCRIPTION OF THE INVENTION

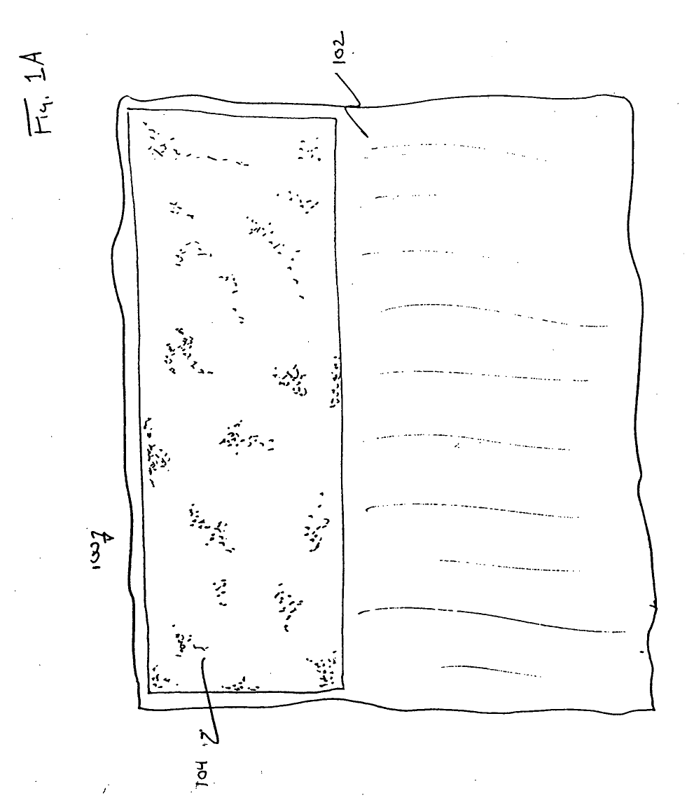

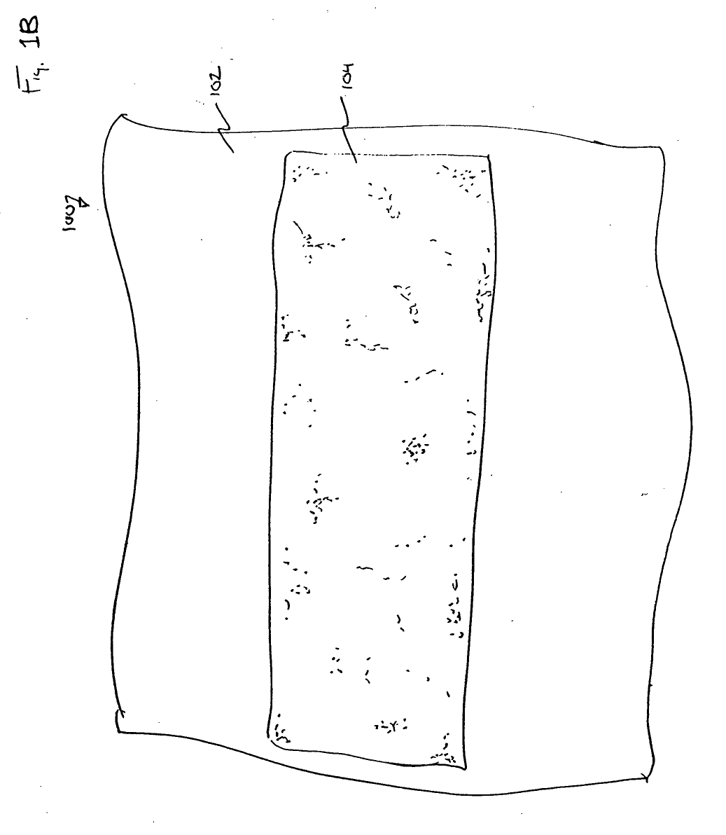

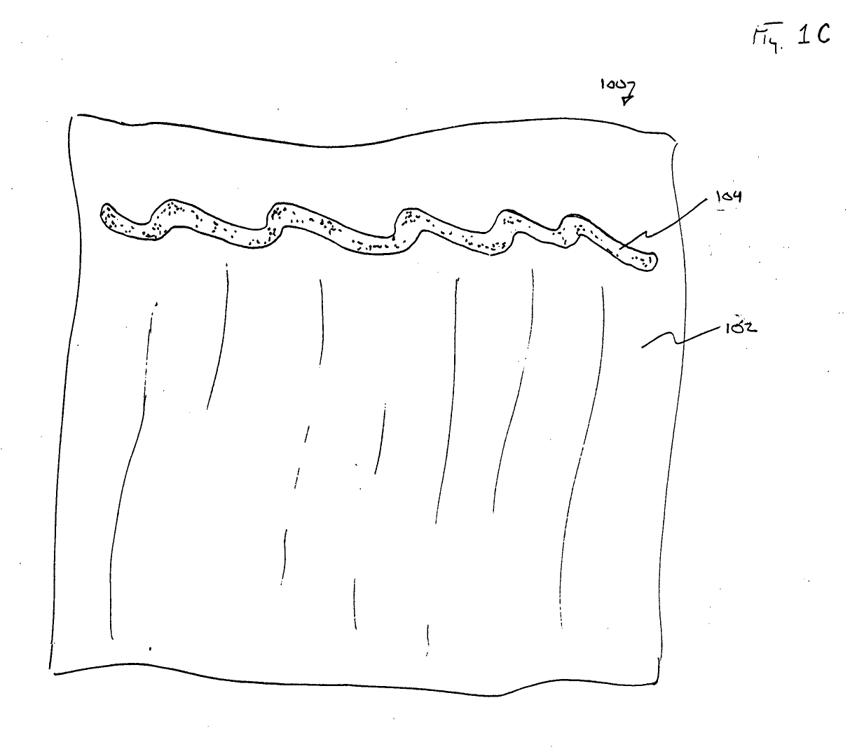

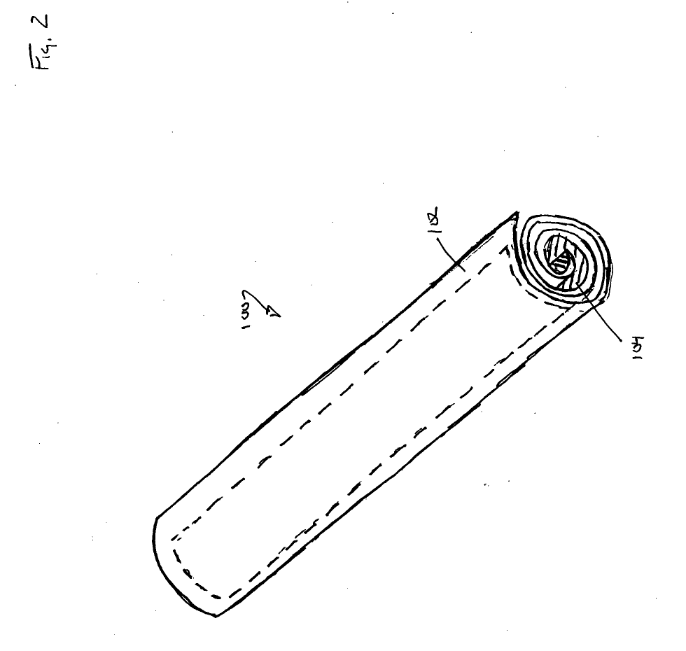

In one embodiment of the present invention (shown generally in FIGS. 1A-2), a rawhide pet chew 100 is generally composed of a rawhide strip or sheet 102 (or other formed piece of rawhide) having a flavor additive 104 applied to at least a portion thereof. The flavor additive 104 (such as a flavor enhancer or palate enhancer) is typically placed along a portion of one side of the rawhide sheet 102, after which the sheet is formed into its final configuration. In its final configuration, the flavor additive 104 is typically, although not always, substantially surrounded by the rawhide sheet 102. The location of the flavor additive in the final product 100 depends on the position of the applied flavor additive prior to forming the final chew shape.

Initially, the rawhide is processed according to standard practices. One such standard practice is that the rawhide is procured in the split lime state, generally as by-products from tanneries. All the hides are placed into processing drums to be washed and whitened using a solution of hydrogen peroxide. Standard practices for processing rawhide typically include additional steps that are known in the industry, for example, checking the pH of the hides and modifying the pH as necessary.

Some of the hides may be separated and dried, and later flavored in a variety of manners. Alternately, portions of each hide may be separated for later uses. Such hides may be flavored by, for example, marinating prior to cutting the hide or forming the chew 100, or by basting after the chew is formed (or “tied”) and dried. For instance, such processes may include soaking the hide in a flavored solution, applying a flavored coating or gravy to the finished, dried chew, or by marinating the hides in a flavored solution that is eventually dried on the hides' surface. The marination process may also soak some of the flavored solution into the pores of the hides, thus at least partially penetrating the hides prior to drying, as described below.

In one embodiment, the hides may be placed in a tank for marinating. The marinade may be a solution of natural or artificial flavoring that is enticing to pets in taste and smell. The marinade may further include a dye or other coloring to make the rawhide visually enticing to either or both the pet and the pet owner. The flavoring technique or process used may result in the impregnation of the flavoring into the rawhide, rather than merely providing a coating.

Either type of hide (i.e., standard whitened and/or flavored) is then cut while still at least slightly wet into appropriate patterns to be formed into the desired pet chew. Sheets or strips, made of either the standard whitened hide, the flavored hide, or a combination thereof, are variously wrapped, rolled, or tied together to create various types of shaped pet chews.

Prior to wrapping, rolling, or otherwise tying the final shape of the rawhide chew 100, a flavor additive 104 or flavor enhancer is added to the rawhide strip. The flavor additive is often a dry or powdered substance; alternate embodiments may employ a syrup or other relatively thick or viscous liquid or a granular solid. The flavor additive 104 is added to a portion of the rawhide strip 102, as shown in FIG. 1A. For example, the flavor additive 104 may be applied along a third, a half, or a quarter of the sheet 102, and may be applied along the length or width of the sheet. It is contemplated that the flavor additive may be positioned virtually anywhere on the unwrapped hide section, so as to be positioned in a particular desired location once the chew is formed.

Typically, however, the flavor additive 104 is applied such that the entire rawhide chew 100, once formed, encloses at least some flavor additive. For example, FIG. 1A depicts the flavor additive 104 applied along the length of a rawhide strip 102. Turning briefly to FIG. 2, it may be seen that the strip has been formed into a roll shape 100. Accordingly, and with respect to FIG. 1A, the flavor additive 104 is applied along the length of the strip 104 to ensure the flavor additive is present along the entire length of the roll 100.

Although FIG. 1A depicts a relatively flat, rectangular rawhide sheet 102, the flavor additive 104 may be applied to any portion of a rawhide sheet, strip, or chip of any shape. The flavor additive 104 may be applied, for example, to rawhide sheets 102 used to form a rawhide chew taking the shape of a bone, bagel, donut, roll, twist, or any other shape. Further, although FIG. 1A depicts the flavor additive applied to only one side of the rawhide, alternate embodiments may apply the flavor additive to both sides, or to a different portion of the rawhide. For example, FIG. 1B depicts the flavor additive 104 applied to the middle third of a rawhide sheet 102. In yet other embodiments, the flavor additive may be added to small chips or pieces of rawhide that are not further tied or folded as described below. Either dry or liquid flavor additives may be added to rawhide chips.

Various flavor additives 104 may be used in the present embodiment. For example, OPTIMIZOR Premium Liquid Dog Palatability Enhancer, OPTIMIZOR Basting Dog Treat Palatability Enhancer, OPTIMIZOR Lone Star Liquid Dog Palatability Enhancer, OPTIMIZOR Concentrate 6C2, and/or OPTIMIZOR CHX H-Base, all produced by Applied Food Biotechnology, Inc. of O'Fallon, M O, are suitable for use as a flavor additive, as are similar products made by other manufacturers.

It should be noted the aforementioned flavor enhancers/additives 104 are provided as examples of additives suitable for use in various embodiments of the invention, and accordingly are meant to be illustrative rather than limiting. Exemplary flavor additives 104 (both those previously mentioned and others suitable for use with the present invention) may take the form of liquid or solid additives having a variety of flavors, such as poultry, beef, pork, and so forth.

One exemplary liquid flavor additive 104 consists of 75% moisture (such as water, a saline solution, and/or or a glycerine solution) 5% protein, 7% fat, 4% ash, and 7% other materials, such as thickeners, preservatives, colorings, and so forth. These percentages are approximate, and may vary widely according to the liquid flavor additive 104 used. For example an alternative liquid flavor enhancer 104 contains approximately 75% moisture, 3.5% protein, 4.5% fat, 6.5% ash, with the balance made of a variety of materials. Yet another flavor additive is made of 6% or less moisture, 54% protein, 16% fat, 4.5% ash, with the balance a variety of other materials. This third flavor enhancer 104 is a more concentrated, less liquid enhancer than the first two discussed. Similarly, yet another flavor enhancer may consist of less than 4% moisture, 38% protein, 23% fat, 7.5% ash, and the balance made of other materials.

The various flavor enhancers 104 discussed herein may be added to a rawhide chew directly, or may be used to form a solution with water or another liquid. The solution may then be applied to the rawhide sheet 102.

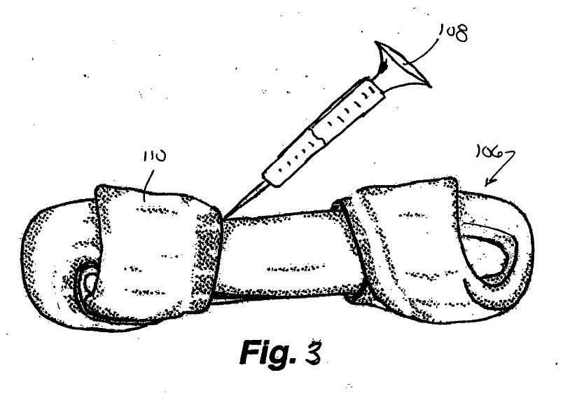

Although any amount of liquid flavor additive 104 may be added to the rawhide sheet 102 without departing from the spirit or scope of the present invention, one embodiment adds from two to ten milliliters of flavor additive to a standard-sized rawhide sheet 102 used, for example, to make a roll-shaped chew. This sheet may measure ten inches by five inches, ten inches by twenty inches, three inches by nine inches, and so forth. The exact measurements of the sheet 102 (as well as the exact amount of flavor additive 104 added) may vary between embodiments. FIG. 1C depicts a liquid flavor additive 104 added to a rawhide sheet 102. The liquid flavor additive is shown added to the top of the sheet. In alternate embodiments, the liquid (and/or dry) flavor additive 104 may be added along any portion of the sheet 102, in any amount, and in any shape or pattern desired, forming lines, dots, broken lines, curves, and so forth. The liquid flavor additive may be added, for example, by a squeeze bottle, a mechanized process, a tube, needle, or syringe, and so forth. For example, FIG. 3 depicts a liquid flavor additive 104 being added by a syringe 108 to a formed chew 110. The syringe 108 may be used not only to inject the additive 104 to a finally-formed chew 110, but also to impregnate the rawhide sheet 102 with the additive 104.

Similarly, although any amount of dry flavor additive 104 may be added to the rawhide sheet 102 without departing from the spirit or scope of the invention, one embodiment may add dry flavor additive to water to form a solution, which is in turn applied to the rawhide sheet. One version of the dry flavor additive 104 may constitute from 0.5% to 3% of the solution, by volume. Alternate embodiments may add the dry flavor additive to the solution in different percentages.

Again, the dry flavor additive 104 may also be added directly to the rawhide sheet 102 without suspending it in solution. For example, the dry flavor additive may be added to the rawhide by shaking the flavor additive directly onto the rawhide surface, prior to tying the rawhide.

Typically, the flavor additive 104 is applied to the rawhide sheet 102 while the sheet itself is still somewhat wet or damp. Because the rawhide 102 is still wet, the rawhide surface pores are dilated. As the rawhide dries, the pores generally contract. By adding the flavor additive 104 while the pores are open, the flavor additive may be absorbed by the pores and may become at lest partially trapped in the interior of the rawhide, thus attaining a stronger bond with the rawhide than would occur if the flavor additive were simply pasted or basted onto dry rawhide. The flavor additive 104 can also be applied as a surface coating in some embodiments.

Generally, once the flavor additive 104 is applied, the rawhide sheets 102 or strips are substantially folded, wrapped, rolled, or otherwise tied. FIG. 2 depicts a roll-shaped rawhide chew 100 after forming. The location of the flavor additive 104 is depicted by the dashed lines, which serve only to mark the approximate boundaries of the flavor additive and are not visible on the exterior of the chew. Similarly, the flavor additive 104 generally is not present on the exterior chew surface when the chew 100 is finally tied and dried. The portions of the flavor additive visible to the eye in FIG. 2 are shown by diagonal shading. In alternative embodiments, the flavor additive may extend across a greater or lesser surface area of the rawhide sheet 102, and correspondingly more or less additive may be visible in the formed roll 100.

Typically, the end to which flavor additive 104 is applied forms the inner layer of the rawhide chew 100, enclosed by the non-flavored portion of the sheet 102. In other words, the rawhide sheet 102 shown in FIG. 1A would be rolled starting with the edge having the flavor additive 104 applied thereto, and terminating with the edge not having any flavor additive applied thereto. In this manner, the flavor additive is contained within the middle of the formed roll, and may further entice animals to continue gnawing the rawhide chew to extract the flavor additive. The roll 100 may, for example, contain flavor additive 104 only on portions of the sheet 102 covered by another turn of the sheet. In this manner, the interior side of any exposed portion of the sheet 102 may have no flavor additive 104 thereon. Since the flavor additive is effectively encircled by two layers of rawhide, the animal cannot simply bite through the outer rawhide layer to get to the flavor additive. This, in turn, may extend the length of time the animal chews on or otherwise interacts with the chew 100.

In another embodiment, a rawhide sheet 102 or strip flavored with a flavor additive 104 may be substantially folded, wrapped, or rolled within, or otherwise covered by a sheet or strip of whitened hide. In this alternate embodiment, the flavored hide pieces are typically arranged in such a way with respect to the respective whitened hide pieces that a small edge or other portion of the flavored hide piece, and possibly the flavor additive 104, is exposed to entice chewing and consumption of the finished pet chew by a pet.

Formed pet chews 100 may be dried, for example, on racks in climate controlled chambers. Care should be taken not to dry the pet chews 100 too quickly because, while the exterior of the pet chews may appear dry, the interior, if still moist, can mold and deteriorate before the pet chew reaches the consumer for purchase. This drying process is basically a form of accelerated dehydration.

The inventive pet chew 100 may be prepared in multiple forms that may variously appeal to different animals. Although the embodiment described herein takes the form of a roll 100, alternate embodiments may be formed into bones 106, rolls having knuckles at either or both ends, tori, animal or food shapes, and so forth. All such alternative shapes are embraced by the spirit and scope of this invention.

Other applications of the flavor additive include the use of a syringe 108 to inject the flavor additive into a specific location on the chew 100. One such application is to have the flavor additive 104 injected into one or both of the knots 110 of a bone-shaped chew 106, as shown generally in FIG. 3. The flavor additive 106 may be injected into the portion of the knot 110 closest to the shank of the chew, into the end of the knot, or at any other portion of the knot. Each knot may have a different flavor applied. The flavor additive 104 may be applied after the bone-shaped chew 106 is formed and before it is dried, or it can be applied at another stage of the process. The flavor additive can be applied in its powdered or dry granular form from a shaker, by hand, or with an implement, such as a spoon or scoop. The liquid, slurry or syrupy form of the flavor enhancer 104 can be applied with a syringe, cup, sprayer or other liquid-applying apparatus 108. The more physically discrete the application technique (i.e. syringe application compared to a spray application), the more strategic the placement of the flavor material 104 is on the chew 106. More physically discrete application techniques may also permit finer control over the amount of flavor additive added.

The flavor additive 104 may have a flavor distinct from any other flavor used on the chew 100, in order to provide additional incentive for the pet to chew on the pet chew. The flavor additive 104 may have a different texture than the other surfaces of the chew 100. The flavor additive may be, for example, relatively sticky or gritty. Multiple flavor additives may be used on a single chew to provide a variety of enticements to a pet. The flavor additive 104 may also be more flavorful than other flavors added to the chew 100, such as by basting or marinating, to provide further flavor enhancement.

Although various embodiments of this invention have been described above with a certain degree of particularity, or with reference to one or more individual embodiments, those skilled in the art could make numerous alterations to the disclosed embodiments without departing from the spirit or scope of this invention. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A rawhide pet chew comprising:
a first sheet of rawhide; and
a flavor additive applied to at least a portion of the first sheet of rawhide; wherein
the flavor additive is substantially enclosed by the first sheet of rawhide.

2. The rawhide pet chew of claim 1, wherein:
the flavor additive is a dry additive.

3. The rawhide pet chew of claim 1, wherein:
the flavor additive is a liquid additive.

4. The rawhide pet chew of claim 3, wherein the liquid additive comprises:
6% to 75% moisture;
3.5% to 54% protein; and
4.5% to 16% fat.

5. The rawhide pet chew of claim 3, wherein the liquid additive comprises:
4% moisture;
38% protein;
23% fat; and
7.5% ash.

6. The rawhide pet chew of claim 1, wherein the chew is roll-shaped.

7. The rawhide pet chew of claim 6, wherein:
the flavor additive is applied to a first side of the first rawhide sheet; and
the rawhide sheet covers the flavor additive at least twice.

8. The rawhide pet chew of claim 7, wherein the flavor additive is placed solely on an upper third of the rawhide sheet.

9. The rawhide pet chew of claim 1, wherein the flavor additive is applied solely to a middle third of the rawhide sheet.

10. The rawhide pet chew of claim 1, wherein the chew is bone-shaped.

11. The rawhide pet chew of claim 10, wherein the flavor additive is applied to an interior portion of a knot formed at a first end of the bone-shaped chew.

12. The rawhide pet chew of claim 11, wherein the flavor additive is applied to an interior portion of a second know formed at a second end of the bone-shaped chew.

13. The rawhide chew of claim 1, further comprising:
a second flavor additive applied to a second portion of the rawhide sheet; wherein
the first and second flavor additives are different flavors.

14. The rawhide chew of claim 1, further comprising:
a second rawhide sheet;
a second flavor additive applied to a first portion of the second rawhide sheet;
wherein
the first rawhide sheet at least partially encloses the second rawhide sheet.

15. The rawhide chew of claim 14, wherein the first and second flavor additives are different flavors.

16. A method for forming a rawhide pet chew, comprising:
applying a flavor additive to a partially wet rawhide strip to form a flavored portion and an unflavored portion;
forming the rawhide strip into a rawhide pet chew, wherein the unflavored portion of the rawhide strip covers the flavored portion of the rawhide strip; and
drying the rawhide pet chew, wherein the drying bonds the flavor additive to the rawhide strip.

17. The method of claim 13, wherein the flavor additive is a powder.

18. The method of claim 13, wherein the flavor additive is a liquid.

19. The method of claim 15, wherein the liquid flavor additive comprises:
6% to 75% moisture;
3.5% to 54% protein; and
4.5% to 16% fat.

20. A method for forming a rawhide chew, comprising:
cutting a rawhide strip from a sheet of rawhide;
forming the rawhide into a shape;
drying the rawhide; and
after drying the rawhide, injecting a flavor additive into the rawhide chew.

21. The method of claim 20, wherein:
the rawhide is formed into a bone shape; and
the flavor is injected into a knot formed in the bone.
